(19) United States
(12) Patent Application Publication
(10) Pub. No.: US 2026/0167190 A1
(43) Pub. Date: Jun. 18, 2026

(54) SYSTEM AND METHOD FOR SERVER-BASED INTELLIGENT DRIVING CONTROL OF A VEHICLE

(71) Applicants: HYUNDAI MOTOR COMPANY, Seoul (KR); KIA CORPORATION, Seoul (KR)

(72) Inventors: Lawoo Kim, Hwaseong-si (KR); Hanshik Kim, Hwaseong-si (KR)

(73) Assignees: HYUNDAI MOTOR COMPANY, Seoul (KR); KIA CORPORATION, Seoul (KR)

(21) Appl. No.: 19/230,038

(22) Filed: Jun. 5, 2025

(30) Foreign Application Priority Data
Dec. 16, 2024 (KR) 10-2024-0186672

(51) Int. Cl. B60W 30/14

(52) U.S. Cl. CPC B60W 30/146; B60W 2520/10; B60W 2555/20; B60W 2555/60; B60W 2556/40; B60W 2556/50

(57) ABSTRACT

A system for server-based intelligent driving control of a vehicle includes a vehicle driving control apparatus configured to receive a satellite navigation signal transmitted from a satellite navigation system and generate position information of the vehicle. The system further includes a server configured to receive the position information of the vehicle from the vehicle driving control apparatus and transmit, to the vehicle driving control apparatus, a speed limit corresponding to the position information of the vehicle. The vehicle driving control apparatus is configured to control the vehicle to drive at or below a maximum speed of the vehicle and limit the maximum speed of the vehicle to the received speed limit.

### CROSS-REFERENCE TO RELATED APPLICATION

This present application claims the benefit of and priority to Korean Patent Application No. 10-2024-0186672, filed on Dec. 16, 2024, in the Korean Intellectual Property Office, the entire contents of which are incorporated herein by reference.

### TECHNICAL FIELD

The present disclosure relates to a system and a method for server-based intelligent driving control of a vehicle. More particularly, the present disclosure relates to a system and a method for server-based intelligent vehicle driving control that control vehicle driving via a server.

### BACKGROUND

An advanced driver assistance system refers to a technology that supports a driver to enhance the safety and convenience of vehicle driving.

For example, the advanced driver assistance system may provide functions, such as automatic inter-vehicle distance control, constant speed maintenance, lane keeping, emergency braking, lane change assistance, parking assistance, and intelligent speed limit assistance.

Among these, the intelligent speed limit assistance is a service that provides a warning alert to the driver when the speed of the vehicle during driving exceeds the speed limit for each road link. However, existing intelligent speed limit assistance devices have the problem of providing speed limit data that is not updated. As a result, drivers have to continuously monitor the front to check the real-time speed limit in variable speed zones, causing inconvenience.

Furthermore, because the existing intelligent speed limit assistance devices perform computational processing in a navigation device, the hardware requirements of the vehicle increased, the processing time was prolonged, and big data analysis is not possible. Thus, this makes it impossible to provide map matching results based on big data analysis.

In addition, the existing intelligent speed limit assistance devices have a problem of low accuracy in map matching, which refers to matching the vehicle position on a map.

Moreover, the existing intelligent speed limit assistance devices have a problem of only providing a warning sound when the speed limit for each road link is exceeded and thus requiring the driver to manually adjust the speed. The subject matter described in this background section is intended to promote an understanding of the background of the disclosure and thus may include subject matter that is not already known to those of ordinary skill in the art. The statements in this section merely provide background information related to the present disclosure and may not constitute prior art.

### SUMMARY

The present disclosure is directed to a system and a method for server-based intelligent driving control of a vehicle. The system and the method may extract a real-time speed limit corresponding to the position of a vehicle and may control the vehicle based on the extracted speed limit.

Further, the present disclosure is directed to a system and a method for server-based intelligent driving control of a vehicle. The system and the method may perform computational processing in a server to extract a real-time speed limit and may control a vehicle based on the extracted speed limit.

In addition, the present disclosure is directed to a system and a method for server-based intelligent driving control of a vehicle. The system and the method may analyze a large amount of global navigation satellite system (GNSS) trajectories in a server linked to an electronic map to extract a real-time speed limit and may control a vehicle based on the extracted speed limit.

Furthermore, the present disclosure is directed to a system and a method for server-based intelligent driving control of a vehicle. The system and the method may automatically control a vehicle based on the speed limit for each road link.

Aspects of the present disclosure is not limited to those mentioned above. Other aspects and advantages not mentioned above should be understood from the following description and should become more apparent from the embodiments. Moreover, aspects of the present disclosure may be realized by the means and combinations thereof indicated in claims.

An aspect of the present disclosure provides an apparatus for server-based intelligent driving control of a vehicle. The apparatus includes a position information generation unit configured to receive a satellite navigation signal transmitted from a satellite navigation system and generate position information of the vehicle. The apparatus further includes a transmission unit configured to transmit the position information of the vehicle to a server through a communication network. The apparatus further includes a reception unit configured to receive, from the server, a speed limit based on the position information of the vehicle. The apparatus further includes a control unit configured to control the vehicle to drive at or below a maximum speed of the vehicle and limit the maximum speed of the vehicle to the received speed limit.

The control unit may be configured to monitor a speed of the vehicle; and when the speed of the vehicle exceeds the speed limit, control at least one of motor output, fuel injection amount, fuel injection timing, or a braking device of the vehicle to reduce the speed of the vehicle to or below the speed limit.

Another aspect of the present disclosure provides a server for intelligent driving control of a vehicle. The server includes a reception unit configured to receive position information of the vehicle from a vehicle driving control apparatus. The server further includes a matching unit configured to match the position information of the vehicle to a road map including road nodes and road links. The server further includes an identifier extraction unit configured to extract an identifier of a road link corresponding to the matched position information. The server further includes a speed limit detection unit configured to detect, from the database, a speed limit corresponding to the identifier of the road link. The server further includes a transmission unit configured to transmit the detected speed limit to the vehicle driving control apparatus.

The matching unit may be configured to determine a speed of the vehicle based on the position information of the vehicle and a time point at which the position information is received; determine whether the position information of the vehicle is erroneous based on the determined speed of the vehicle; and delete the position information determined to be erroneous.

The matching unit may be configured to extract road links existing within a predetermined radius based on the position information. The matching unit may be configured to determine an initial probability of the extracted road links. The matching unit may be configured to update the initial probability for each road link in chronological order of receiving the position information by determining probabilities of the vehicle moving from the road links extracted based on received position information to road links extracted based on subsequently received position information. The matching unit may be configured to, when updating is completed by determining a probability of the vehicle moving to road links extracted based on final position information, generate a vehicle trajectory by selecting the road link with the highest probability for each piece of position information, in reverse chronological order starting from the road link with the highest probability among the road links extracted based on the final position information. The matching unit may be configured to detect overlapping paths in the vehicle trajectory. The matching unit may be configured to correct the overlapping paths.

The matching unit may be configured to generate the vehicle trajectory based on the position information of the vehicle and the road link via a machine learning model trained by using position information accumulated in the database as training data.

The database may be updated with the speed limit for each road link based on real-time weather data and a variable speed limit zone comprising at least one of a frequent fog area, a frequent rainfall area, a frequent snowfall area, a frequent freezing area, a frequent traffic congestion area, a time-based child protection zone, a time-based senior protection zone, or a construction zone.

Yet another aspect of the present disclosure provides a system for server-based intelligent driving control of a vehicle. The system includes a vehicle driving control apparatus configured to receive a satellite navigation signal transmitted from a satellite navigation system and generate position information of the vehicle. The system further includes a server configured to receive the position information of the vehicle from the vehicle driving control apparatus and transmit a speed limit corresponding to the position information of the vehicle to the vehicle driving control apparatus. The vehicle driving control apparatus is configured to control the vehicle to drive at or below a maximum speed of the vehicle and limit the maximum speed of the vehicle to the speed limit received from the server.

The server may be configured to determine the speed of the vehicle based on the position information of the vehicle and a time point at which the position information is received; determine whether the position information of the vehicle is erroneous based on the determined speed of the vehicle; and delete the position information determined to be erroneous.

The server may be configured to extract road links existing within a predetermined radius based on the position information. The server may be further configured to determine an initial probability of the extracted road links. The server may be further configured to update the initial probability for each road link in chronological order of receiving the position information by determining probabilities of the vehicle moving from the road links extracted based on received position information to road links extracted based on subsequently received position information. The server may be further configured to, when updating is completed by determining a probability of the vehicle moving to road links extracted based on final position information. The server may be further configured to generate a vehicle trajectory by selecting the road link with a highest probability for each piece of position information, in reverse chronological order starting from the road link with the highest probability among the road links extracted based on the final position information. The server may be further configured to detect overlapping paths in the trajectory of the vehicle. The server may be further configured to correct the overlapping paths.

The vehicle driving control apparatus may be configured to monitor a speed of the vehicle; and when the speed of the vehicle exceeds the speed limit, control at least one of motor output, fuel injection amount, fuel injection timing, or a braking device of the vehicle to reduce the speed of the vehicle to or below the speed limit.

Still another aspect of the present disclosure provides a method for server-based intelligent driving control of a vehicle. The method includes receiving, by a vehicle driving control apparatus, a satellite navigation signal transmitted from a satellite navigation system to generate position information of the vehicle. The method further includes transmitting, by the vehicle driving control apparatus, the position information of the vehicle to a server through a communication network. The method further includes matching, by the server, the position information of the vehicle to a road map comprising road nodes and road links. The method further includes detecting, by the server, a speed limit corresponding to the matched position information. The method further includes transmitting, by the server, the speed limit to the vehicle driving control apparatus through the communication network. The method further includes controlling, by the vehicle driving control apparatus, the vehicle to drive at or below a maximum speed of the vehicle. The method further includes controlling, by the vehicle driving control apparatus, the maximum speed of the vehicle to the received speed limit.

Matching the position information of the vehicle to the road map may include determining a speed of the vehicle based on the position information of the vehicle and a time point at which the position information is received. Matching the position information of the vehicle to the road map may further include determining whether the position information of the vehicle is erroneous based on the determined speed of the vehicle. Matching the position information of the vehicle to the road map may include deleting the position information determined to be erroneous.

Matching the position information of the vehicle to the road map may include extracting road links existing within a predetermined radius based on the position information. Matching the position information of the vehicle to the road map may include determining an initial probability of the extracted road links. Matching the position information of the vehicle to the road map may include updating the initial probability for each road link in chronological order of receiving the position information by determining probabilities of the vehicle moving from the road links extracted based on received position information to road links extracted based on subsequently received position information. Matching the position information of the vehicle to the road map may include, when updating is completed by determining a probability of the vehicle moving to road links extracted based on final position information, generating a vehicle trajectory by selecting the road link with a highest probability for each piece of position information, in reverse chronological order starting from the road link with the highest probability among the road links extracted based on the final position information.

Matching the position information of the vehicle to the road map may include detecting overlapping paths in the vehicle trajectory and correcting the vehicle trajectory by removing the overlapping paths.

Matching the position information of the vehicle to the road map may further include generating the vehicle trajectory based on the position information of the vehicle and the road links via a machine learning model trained by using position information and the vehicle trajectory accumulated in a database as training data.

The method may further include updating database with the speed limit for each road link based on real-time weather data and a variable speed limit zone comprising at least one of a frequent fog area, a frequent rainfall area, a frequent snowfall area, a frequent freezing area, a frequent traffic congestion area, a time-based child protection zone, a time-based senior protection zone, or a construction zone.

Detecting the speed limit may include extracting, by the server, an identifier of the road link corresponding to the matched position information; and detecting, by the server, a speed limit corresponding to the identifier of the road link from the database.

According to the present disclosure, by automatically providing real-time speed limits corresponding to the vehicle position, the apparatus, the system, and the method for server-based intelligent driving control of a vehicle according to the present disclosure reduce the driver's burden of monitoring road signs, vehicle control based on up-to-date real-time speed limits becomes possible, and thus driving convenience may be enhanced.

Furthermore, by performing computational processing on the server, the apparatus, the system, and the method for server-based intelligent driving control of a vehicle according to the present disclosure shorten processing time, enable real-time vehicle speed control, and reduce manufacturing costs and vehicle weight by eliminating the need for an onboard computational processing device.

In addition, the apparatus, the system, and the method for server-based intelligent driving control of a vehicle according to the present disclosure analyze a large volume of GNSS trajectories, map matching performance can be enhanced using big data, and thus real-time vehicle control may be enabled based on speed limits derived from more accurate position data.

Moreover, according to the present disclosure, because the vehicle is automatically controlled based on the speed limit for each road link, driving convenience can be enhanced.

### BRIEF DESCRIPTION OF THE DRAWINGS

The foregoing and other aspects, features, and advantages, as well as the following detailed description of the embodiments, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a block diagram of a server-based intelligent vehicle driving control system according to an embodiment of the present disclosure.

FIG. 2 is a flowchart illustrating a method for a server-based intelligent vehicle driving control according to an embodiment of the present disclosure.

FIG. 3 is a diagram illustrating an example of a map service among infotainment services.

FIG. 4 is a diagram illustrating an example of server-based vehicle driving control according to an embodiment of the present disclosure.

### DETAILED DESCRIPTION

Hereinafter, embodiments disclosed in the present document are described in detail with reference to the accompanying drawings. Like reference numerals designate like elements, and redundant descriptions thereof have been omitted. Further, the terms, such as “module” and a “unit”, used in the present disclosure are intended to describe the components and do not have a meaning or role distinguished from each other. In addition, in describing an embodiment disclosed in the present document, if it is determined that a detailed description of a related art incorporated herein unnecessarily obscures the gist of the embodiment, the detailed description thereof has been omitted. Furthermore, it should be understood that the appended drawings are intended only to help understand embodiments disclosed in the present document and do not limit the technical principles and scope of the present disclosure. Instead, it should be understood that the appended drawings include all of the modifications, equivalents, or substitutes described by the technical principles and belonging to the technical scope of the present disclosure.

Although the terms, such as first, second, and the like, may be used herein to describe various elements, these elements should not be limited by these terms. These terms are generally only used to distinguish one element from another.

When an element or layer is referred to as being “on,” “engaged to,” “connected to,” or “coupled to” another element or layer, the element or the layer may be directly on, engaged, connected, or coupled to another element or another layer, or intervening elements or layers may be present. In contrast, when an element is referred to as being “directly on,” “directly engaged to,” “directly connected to,” or “directly coupled to” another element or layer, there may be no intervening elements or layers present. When a controller, apparatus, module, component, device, element, or the like of the present disclosure is described as having a purpose or performing an operation, function, or the like, the controller, apparatus, module, component, device, element, or the like should be considered herein as being “configured to” meet that purpose or to perform that operation or function. Each controller, apparatus, module, component, device, element, and the like may separately embody or be included with a processor and a memory, such as a non-transitory computer readable media, as part of the apparatus.

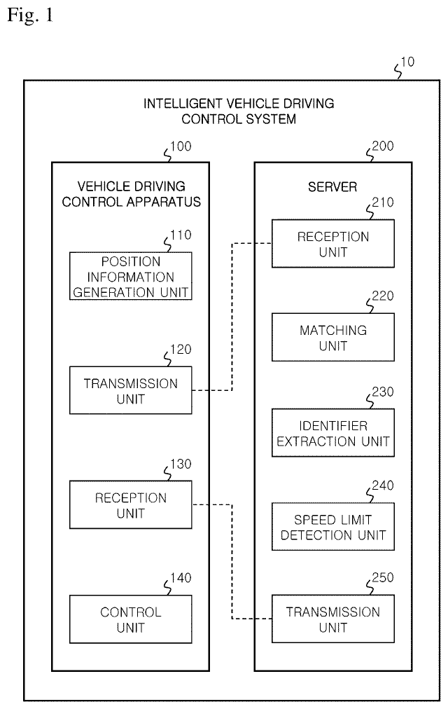

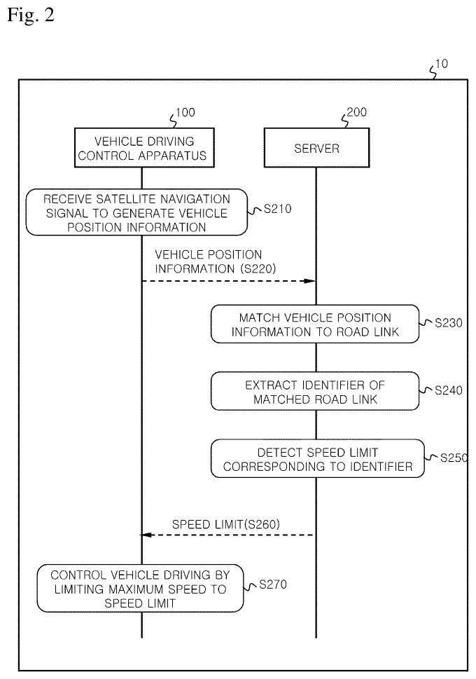

Hereinafter, a system and a method for server-based intelligent driving control of a vehicle according to the present disclosure are described in detail with reference to FIGS. 1 and 2.

FIG. 1 is a block diagram of a server-based intelligent driving control system of a vehicle according to an embodiment of the present disclosure, and FIG. 2 is a flowchart illustrating a method for a server-based intelligent driving control of a vehicle according to an embodiment of the present disclosure.

Referring to FIG. 1, a server-based intelligent vehicle driving control system 10 according to an embodiment of the present disclosure may comprise a server-based intelligent vehicle driving control device 100 and a server 200.

The server-based intelligent vehicle driving control device 100 may comprise a position information generation unit 110, a transmission unit 120, a reception unit 130, a control unit 140, and the like.

The position information generation unit 110 receives satellite navigation signals transmitted from a satellite navigation system and generates position information of a vehicle (see S210 of FIG. 2).

For example, the position information generation unit 110 may calculate or determine the signal propagation time by comparing the position and time information transmitted by a satellite with the current time information and may determine the distance between the satellite and the vehicle based on the signal propagation time.

A satellite navigation system refers to a system of satellites that provide signals for transmitting position and time information to a satellite navigation receiver.

The satellite navigation system may comprise, for example, Galileo of Europe, the Global Positioning System (GPS) of the United States, the Global'naya Navigatsionnaya Sputnikovaya Sistema (GLONASS) of Russia, and the BeiDou Navigation Satellite System of China.

For example, the position information generation unit 110 receives a plurality of satellite signals from a plurality of GNSS satellites by using a plurality of antennas. The position information generation unit 110 can also detect the movement of the vehicle using a dead reckoning (DR) sensor.

The DR sensor may be configured to detect the vehicle rotation angle by using a gyro sensor and calculate or determine the number of rotations per hour of the vehicle wheel or rotating shaft by using an encoder installed on the wheel or rotating shaft, allowing the vehicle speed to be determined.

When the received satellite signal condition is stable, the plurality of pieces of position information may be synthesized to generate vehicle position information.

On the other hand, when the received satellite signal condition is not stable, the vehicle position information may be estimated based on the vehicle movement detected by the DR sensor.

Additionally, the position information generation unit 110 may correct the position information using correction information that follows Radio Technical Commission for Maritime Services (RTCM) standard format, which is received from a reference station.

The transmission unit 120 transmits the vehicle position information to the server 200 through a communication network (see S220 of FIG. 2).

For example, the transmission unit 120 may transmit the vehicle position information to the server 200 by using a vehicle mobile communication modem when the vehicle is subscribed to a mobile communication network. When the vehicle is not subscribed to the mobile communication network, the transmission unit 120 may transmit the vehicle position information to the server 200 by using a tethering function of a mobile communication terminal that is subscribed to the mobile communication network.

The transmission unit 120 converts the position information into a suitable format for transmission and, when the vehicle is connected to the Internet, may transmit the position information to the server according to a specific protocol and request method.

The server 200 may comprise a receiving unit 210, a matching unit 220, an identifier extraction unit 230, a speed limit detection unit 240, and a transmission unit 250.

The receiving unit 210 receives the vehicle position information from a communication terminal in the vehicle (see S220 of FIG. 2).

The matching unit 220 matches the vehicle position information to a road map that comprises road nodes and road links (see S230 of FIG. 2).

The node refers to a position where a change in speed occurs as the vehicle drives on the road.

For example, types of nodes may comprise intersections, bridge start and end points, overpass start and end points, road start and end points, underpass start and end points, tunnel start and end points, administrative boundaries, and ICs/JCs (interchanges/junctions).

The link refers to a line connecting two nodes and represents a road in the real world.

For example, types of links may comprise roads, bridges, overpasses, underpasses, and tunnels.

The matching unit 220 may filter the position information data collected from a GNSS module.

Typically, unusable position information data is characterized by randomly recorded coordinates within a short period.

Accordingly, the matching unit 220 may determine the vehicle speed based on the coordinates of the position information and time points when the position information is received and may delete position information collected in sections where the vehicle speed is recorded as abnormally high.

The matching unit 220 may calculate or determine a probability that each point of the position information, collected in chronological order, can be connected based on the road map and the vehicle position information.

Accordingly, the matching unit 220 may determine a vehicle route based on the finally determined probability value and may improve the accuracy of the current position information based on the determined route. Vehicle trajectory refers to a path formed by connecting each point of the vehicle position information in chronological order.

The matching unit 220 may set time steps based on the time points when the vehicle position information is received.

For example, when a total of six GNSS measurements are received, six time steps, such as k−3, k−2, . . . , k+2, may be set.

Based on each piece of received position information, multiple possible coordinates where the vehicle may be located may be extracted within a predefined radius for each time step based on the road map, and the initial probabilities of the extracted coordinates may be determined. The time steps are set corresponding to the time points when the position information is received, and the multiple coordinates extracted for each time step refer to coordinates on road links that exist within a predefined distance based on the position information received in chronological order.

For example, five road links may be extracted for matching with the GNSS measurement at the k−3 time step. Six road links may be extracted for matching with the GNSS measurement at the k−2 time step. Five road links may be extracted for matching with the GNSS measurement at the k−1 time step. Seven road links may be extracted for matching with the GNSS measurement at the k time step. Four road links may be extracted for matching with the GNSS measurement at the k+1 time step. Five road links may be extracted for matching with the GNSS measurement at the k+2 time step.

The matching unit 220 may determine the probability of the vehicle moving from each coordinate of the previous time step to a given coordinate and may update the initial probabilities accordingly.

The initial probability may be higher when the distance between the coordinate and the link is shorter.

The probability of the vehicle movement may decrease as the actual movement distance on the road becomes greater than the straight-line distance between GNSS measurements.

For example, when the matching unit 220 estimates the vehicle movement based on the measurement at the k−3 time step and the measurement at the k+2 time step, it may assume that the vehicle has traveled along the shortest road among the roads available for traveling from positions estimated based on the measurement at the k−3 time step to positions estimated based on the measurement at the k+2 time step.

The matching unit 220, at the final time step (k+2 time step), may generate a vehicle trajectory by selecting the coordinate with the highest probability for each time step, in reverse chronological order starting from the coordinate with the highest probability among the coordinates at the final time step.

As an example of generating a trajectory by selecting coordinates in reverse chronological order, when the road link with the highest probability in the final time step (k+2) is referred to as the k+2 maximum probability link, the road link in the k+1 time step that has the highest probability of being connected to the k+2 link may be referred to as the k+1 maximum probability link.

Accordingly, when the generated vehicle trajectory is sequentially represented, it may be expressed as [k−3 maximum probability link, k−2 maximum probability link, k−1 maximum probability link, k maximum probability link, k+1 maximum probability link, k+2 maximum probability link].

Additionally, the matching unit 220 may generate the vehicle trajectory based on at least one of a separation distance between the road link and the trajectory candidate or an angle between the road link and the trajectory candidate.

Meanwhile, when map matching is performed based on the vehicle trajectory recorded in chronological order, a more accurate map matching can be achieved as accessible roads are selected based on the vehicle driving direction.

In addition, the matching unit 220 may determine a similarity by comparing the collected vehicle position information with the position information of other vehicles stored in the server 200. When the similarity is equal to or greater than a predetermined threshold, the matching unit 220 may correct the vehicle position information based on the pre-generated corrected position information of other vehicles.

For example, the matching unit 220 may output a map matching result reflecting the internal connection probabilities between position coordinates and the external connection probabilities between road links using a transformer machine learning model that comprises an encoder-decoder structure.

The matching unit 220 may vectorize position information, including latitude, longitude, time, speed, and movement angle, and the vectored position information may be input into the machine learning model.

The input position information is processed through the decoder to output the vehicle trajectory. The output values after performing map matching may comprise latitude, longitude, and vehicle driving direction.

A common error found in trajectories generated after map matching is the occurrence of duplicate trajectories in a direction parallel or perpendicular to the vehicle driving axis.

Accordingly, the matching unit 220 may filter the generated vehicle trajectory by removing duplicate segments.

Further, data related to road links may be managed by clustering them according to regions.

The identifier extraction unit 230 extracts an identifier of the road link corresponding to the matched position information (see S240 of FIG. 2).

For example, the corrected position information may correspond to a road link located between nodes, and the road link ID, which has each node as a start node and an end node, may be extracted as the identifier.

The speed limit detection unit 240 detects a speed limit corresponding to the identifier of the road link from the database (see S250 of FIG. 2).

The database may be an ISA database that comprises real-time speed limit data for each road link, collected through an intelligent transport system (ITS). The ITS system refers to a system that integrates electronic, control, and communication technologies to provide traffic information and services.

For example, the database may be configured to store and update real-time speed limits for each road link and allow the speed limit detection unit 240 to retrieve the latest speed limit values.

For example, the data stored in the database may comprise information on multiple road links with multiple attributes.

The types of attributes may comprise the road link identifier, start node identifier, end node identifier, number of lanes, road grade, road type, road number, road name, designation as a shared section, ramp code, maximum speed limit, restricted vehicles, restricted load, restricted height, and remarks.

The speed limit for each road link in the database may be updated based on real-time weather data and a variable speed limit zone comprising at least one of a frequent fog area, a frequent rainfall area, a frequent snowfall area, a frequent freezing area, a frequent traffic congestion area, a time-based child protection zone, a time-based senior protection zone, or a construction zone.

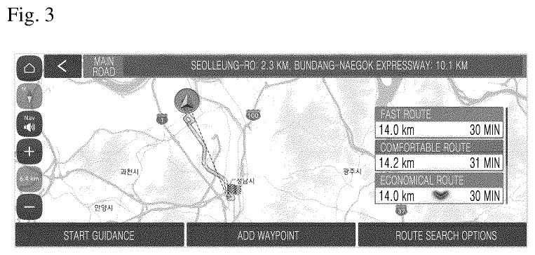

FIG. 3 is a diagram illustrating an example of a map service among infotainment services.

Referring to FIG. 3, in existing vehicles, it is typical for the driver to manually operate the vehicle, and therefore, map data including road nodes and road links, speed limits for each road link, and the like is essential for the driver. Additionally, because the process of matching satellite signals received from GPS modules to the map is also performed in the vehicle, navigation systems performing map matching are essential.

Meanwhile, due to the widespread adoption of mobile navigation apps, consumers are increasingly opting to use mobile navigation services without purchasing separate in-vehicle navigation systems.

However, with the introduction of autonomous driving technology, the need for navigation services for drivers has decreased.

A method for server-based intelligent vehicle driving control according to an embodiment of the present disclosure processes data on the server using data stored therein, enabling its application to vehicles without navigation systems and reducing the required capacity and performance for data processing.

The transmission unit 250 of the server transmits the speed limit to the vehicle driving control device 100.

The reception unit 130 of the vehicle receives the speed limit based on the position information of the vehicle from the server 200 through the communication network (see S260 of FIG. 2).

For example, the reception unit 130 may comprise a communication modem.

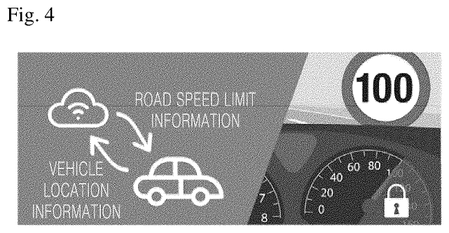

FIG. 4 illustrates server-based vehicle driving control according to an embodiment of the present disclosure.

Referring to FIG. 4, the vehicle driving control device 100 transmits the position information of the vehicle to the server 200 and may receive, from the server 200, road speed limit information, which is the speed limit of the road corresponding to the position information of the vehicle.

When controlling the speed of the vehicle, the control unit 140 limits the maximum speed of the vehicle to the received speed limit (see S270 of FIG. 2)

The control unit 140 may control vehicle driving by adjusting motor output, engine injection quantity, or the braking system when the vehicle speed exceeds the speed limit.

For example, the control unit 140 may be implemented in the form of an ISA controller that monitors the speed of the vehicle, generates control information, and continuously controls motor output, fuel injection quantity, fuel injection timing, and the braking system of the vehicle to reduce the vehicle speed to or below the speed limit when the vehicle speed exceeds the received speed limit.

As used in the present disclosure (especially in the appended claims), the terms “a/an” and “the” include both singular and plural references, unless the context clearly states otherwise. Also, it should be understood that any numerical range recited in the present disclosure is intended to include all sub-ranges subsumed therein (unless expressly indicated otherwise) and accordingly, the disclosed numeral ranges include every individual value between the minimum and maximum values of the numeral ranges.

The steps of the method according to the present disclosure may be performed in an appropriate order unless a specific order is described or otherwise specified. In other words, the present disclosure is not necessarily limited to the order in which the steps are recited. All examples described in the present disclosure or the terms indicative thereof (“for example”, “such as”) are merely to describe the present disclosure in greater detail. Therefore, it should be understood that the scope of the present disclosure is not limited to the embodiments described above or by the use of such terms unless limited by the appended claims. Also, it should be apparent to those having ordinary skill in the art that various modifications, combinations, and alternations may be made based on design conditions and factors within the scope of the appended claims or equivalents thereof.

The present disclosure is thus not limited to the example embodiments described above but intended to include the following appended claims, and all modifications, equivalents, and alternatives should fall within the spirit and scope of the following claims.

What is claimed is:

1. An apparatus for server-based intelligent driving control of a vehicle, the apparatus comprising:
a position information generation unit configured to:
receive a satellite navigation signal transmitted from a satellite navigation system; and
generate position information of the vehicle;
a transmission unit configured to transmit the position information of the vehicle to a server through a communication network;
a reception unit configured to receive, from the server, a speed limit based on the position information of the vehicle; and
a control unit configured to:
control the vehicle to drive at or below a maximum speed of the vehicle ; and
limit the maximum speed of the vehicle to the received speed limit.

2. The apparatus according to claim 1, wherein the control unit is configured to:
monitor a speed of the vehicle; and
when the speed of the vehicle exceeds the speed limit, control at least one of motor output, fuel injection amount, fuel injection timing, or a braking device of the vehicle to reduce the speed of the vehicle to or below the speed limit.

3. A server for intelligent driving control of a vehicle, the server comprising:
a reception unit configured to receive position information of the vehicle from a vehicle driving control apparatus;
a matching unit configured to match the position information of the vehicle to a road map comprising road nodes and road links based on a database within the server;
an identifier extraction unit configured to extract an identifier of a road link corresponding to the matched position information from the database within the server;
a speed limit detection unit configured to detect, from the database within the server, a speed limit corresponding to the identifier of the road link; and
a transmission unit configured to transmit the detected speed limit to the vehicle driving control apparatus,
wherein the database is configured to store and update real-time speed limits for the road links.

4. The server according to claim 3, wherein the matching unit is configured to:
determine a speed of the vehicle based on the position information of the vehicle and a time point at which the position information is received;
determine whether the position information of the vehicle is erroneous based on the determined speed of the vehicle; and
delete the position information determined to be erroneous.

5. The server according to claim 4, wherein the matching unit is configured to:
extract road links existing within a predetermined radius based on the position information;
determine an initial probability of the extracted road links;
update the initial probability for each road link in chronological order of receiving the position information by determining probabilities of the vehicle moving from the road links extracted based on received position information to road links extracted based on subsequently received position information;
when updating is completed by determining a probability of the vehicle moving to road links extracted based on final position information, generate a vehicle trajectory by selecting the road link with a highest probability for each piece of position information, in reverse chronological order starting from the road link with the highest probability among the road links extracted based on the final position information;
detect overlapping paths in the vehicle trajectory; and
correct the vehicle trajectory by removing the overlapping paths.

6. The server according to claim 5, wherein the matching unit is configured to generate the vehicle trajectory based on the position information of the vehicle and the road link via a machine learning model trained by using position information accumulated in the database as training data.

7. The server according to claim 6, wherein the database is updated with the speed limit for each road link based on real-time weather data and a variable speed limit zone comprising at least one of a frequent fog area, a frequent rainfall area, a frequent snowfall area, a frequent freezing area, a frequent traffic congestion area, a time-based child protection zone, a time-based senior protection zone, or a construction zone.

8. A method for server-based intelligent driving control of a vehicle, the method comprising:
receiving, by a vehicle driving control apparatus, a satellite navigation signal transmitted from a satellite navigation system to generate position information of the vehicle;
transmitting, by the vehicle driving control apparatus, the position information of the vehicle to a server through a communication network;
matching, by the server, the position information of the vehicle to a road map comprising road nodes and road links;
detecting, by the server, a speed limit corresponding to the matched position information;
transmitting, by the server, the speed limit to the vehicle driving control apparatus through the communication network;
controlling, by the vehicle driving control apparatus, the vehicle to drive at or below a maximum speed of the vehicle; and
controlling, by the vehicle driving control apparatus, the maximum speed of the vehicle to the received speed limit.

9. The method according to claim 8, wherein matching the position information of the vehicle to the road map comprises:
determining a speed of the vehicle based on the position information of the vehicle and a time point at which the position information is received;
determining whether the position information of the vehicle is erroneous based on the determined speed of the vehicle; and
deleting the position information determined to be erroneous.

10. The method according to claim 9, wherein matching the position information of the vehicle to the road map further comprises:
extracting road links existing within a predetermined radius based on the position information;
determining an initial probability of the extracted road links;
updating the initial probability for each road link in chronological order of receiving the position information by determining probabilities of the vehicle moving from the road links extracted based on received position information to road links extracted based on subsequently received position information;
when updating is completed by determining a probability of the vehicle moving to road links extracted based on final position information, generating a vehicle trajectory by selecting the road link with a highest probability for each piece of position information, in reverse chronological order starting from the road link with the highest probability among the road links extracted based on the final position information;
detecting overlapping paths in the vehicle trajectory; and
correcting the vehicle trajectory by removing the overlapping paths.

11. The method according to claim 10, wherein matching the position information of the vehicle to the road map further comprises:
generating the vehicle trajectory based on the position information of the vehicle and the road links via a machine learning model trained by using position information and the vehicle trajectory accumulated in a database as training data.

12. The method according to claim 11, further comprising:
updating the database with a speed limit for each road link based on real-time weather data and a variable speed limit zone comprising at least one of a frequent fog area, a frequent rainfall area, a frequent snowfall area, a frequent freezing area, a frequent traffic congestion area, a time-based child protection zone, a time-based senior protection zone, or a construction zone.

13. The method according to claim 12, wherein detecting the speed limit comprises:
extracting, by the server, an identifier of the road link corresponding to the matched position information; and
detecting, by the server, a speed limit corresponding to the identifier of the road link from the database.

14. The method according to claim 8, further comprising:
monitoring, by the vehicle driving control apparatus, a speed of the vehicle; and
when the speed of the vehicle exceeds the speed limit, controlling, by the vehicle driving control apparatus, at least one of motor output, fuel injection amount, fuel injection timing, or a braking device of the vehicle to reduce the speed of the vehicle to or below the speed limit.

15. The method according to claim 8, further comprising:
generating a vehicle trajectory based on at least one of a distance between a road link and a trajectory candidate or an angle between the road link and the trajectory candidate.

16. The method according to claim 8, further comprising:
outputting a map matching result reflecting internal connection probabilities between position coordinates and external connection probabilities between road links by using a machine learning model.

17. The method according to claim 16, further comprising:
vectorizing position information, including latitude, longitude, time, speed, and movement angle of the vehicle; and
inputting the vectored position information into the machine learning model.
